(19) United States
(12) Patent Application Publication
(10) Pub. No.: US 2019/0243890 A1
(43) Pub. Date: Aug. 8, 2019

(54) SUGGESTING CONTENT FOR AN ELECTRONIC DOCUMENT BASED ON A USER'S COGNITIVE CONTEXT

(71) Applicant: International Business Machines Corporation, Armonk, NY (US)

(72) Inventors: Shikhar Kwatra, Morrisville, NC (US); Steven R. Joroff, River Vale, NJ (US); Scott E. Schneider, Rolesville, NC (US); Christopher J. Hardee, Raleigh, NC (US)

(21) Appl. No.: 15/888,556

(22) Filed: Feb. 5, 2018

(51) Int. Cl. G06F 17/24; G06F 17/30; G06N 3/08; G06F 17/21; G06F 17/27

(52) U.S. Cl. CPC G06F 17/243; G06F 17/30528; G06F 17/30569; G06N 3/0635; G06F 17/211; G06F 17/276; G06F 17/2765; G06N 3/08

(57) ABSTRACT

Embodiments of the invention are directed to a computer-implemented method that includes receiving, by a controller, information of a user. The information is targeted for inclusion within an application document. The method also includes determining a cognitive context of the user. The method also includes generating, by the controller, an output data comprising a suggested content. The suggested content is based at least in part on the determined cognitive context.

### BACKGROUND

The present invention relates in general to computer systems that generate, store, and edit electronic documents. More specifically, the present invention relates to computer systems configured to determine a content suggestion for creating/editing an electronic document/communication based at least in part on a determined cognitive context of the user.

Computer-based suggesting of content can be used to automatically fill in fields or entries of a document within a computer application. Typically, a user who is filling in fields/entries of the document can use an autofill function to complete the fields/entries with information that the user has previously used to complete previous other fields/entries. For example, if a computer application is able to determine that a set of fields/entries is designated to be filled/completed with a residence address of the user, then the computer application can autofill the set of fields/entries with information that the user previously submitted as the user's residence address.

### SUMMARY

A computer-implemented method according to one or more embodiments of the invention includes receiving, by a controller, information of a user. The information is targeted for inclusion within an application document. The method also includes determining a cognitive context of the user. The method also includes generating, by the controller, an output data comprising a suggested content. The suggested content is based at least in part on the determined cognitive context.

A computer system according to one or more embodiments of the invention includes a memory and a processor system communicatively coupled to the memory. The processor system is configured to perform a method including receiving information of a user. The information is targeted for inclusion within an application document. The method also includes determining a cognitive context of the user. The method also includes generating an output data including a suggested content. The suggested content is based at least in part on the determined cognitive context.

A computer program product according to one or more embodiments of the invention includes a computer-readable storage medium having program instructions embodied therewith. The program instructions are readable by a processor system to cause the processor system to receive information of a user. The information is targeted for inclusion within an application document. The processor system can also be caused to determine a cognitive context of the user. The processor system can also be caused to generate an output data including a suggested content. The suggested content is based at least in part on the determined cognitive context.

### BRIEF DESCRIPTION OF THE DRAWINGS

The subject matter of one or more embodiments is particularly pointed out and distinctly defined in the claims at the conclusion of the specification. The foregoing and other features and advantages are apparent from the following detailed description taken in conjunction with the accompanying drawings in which:

FIG. 1 illustrates inputting information and suggesting content in accordance with one or more embodiments of the invention;

FIG. 2 depicts a flowchart of a method, in accordance with one or more embodiments of the invention;

FIG. 3 depicts a high-level block diagram of a computer system, which can be used to implement one or more embodiments of the invention; and

FIG. 4 depicts a computer program product, in accordance with one or more embodiments of the invention.

### DETAILED DESCRIPTION

Various embodiments of the invention are described herein with reference to the related drawings. Alternative embodiments of the invention can be devised without departing from the scope of this invention. References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments of the invention whether or not explicitly described.

Additionally, although this disclosure includes a detailed description of a computing device configuration, implementation of the teachings recited herein are not limited to a particular type or configuration of computing device(s). Rather, embodiments of the present disclosure are capable of being implemented in conjunction with any other type or configuration of wireless or non-wireless computing devices and/or computing environments, now known or later developed.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments of the invention or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

For the sake of brevity, conventional techniques related to computer processing systems and computing models may or may not be described in detail herein. Moreover, it is understood that the various tasks and process steps described herein can be incorporated into a more comprehensive procedure, process or system having additional steps or functionality not described in detail herein.

With conventional approaches to electronic document/communication creation, when a user completes fields/entries of a document of an application, the application can perform autofill functions on behalf of the user. For example, the application can suggest information to the user, where the suggested information can be used to fill the fields/entries, and where the suggested information can correspond to information that was previously used to fill other previous fields/entries.

With conventional approaches to electronic document/communication creation, when the user begins inputting some information (such as some alphanumeric characters) within a field/entry of a document, the autofill function can attempt to suggest information that is determined based at least in part on the inputted characters. However, the autofill functionality of the conventional approaches are generally limited to suggesting simple words or phrases that the user has already previously entered for previous fields/entries.

In accordance with one or more embodiments of the invention, methods and computer program products for determining a content suggestion based at least in part on a determined cognitive context are provided. In contrast to conventional approaches to electronic document/communication creation, one or more embodiments of the invention can provide suggestions of content based at least in part on a high-level analysis that determines a cognitive context of the user. Determining a cognitive context generally means: (1) to determine which information sources that a user considers to be relevant and/or reliable, (2) to determine suggested content that the user is more likely to input into the application document, and/or (3) to determine how to modify/reformat the suggested content into a form that the user prefers. In contrast to conventional approaches, by suggesting content to the user based at least in part on a high-level analysis of the user's cognitive context, one or more embodiments of the invention can suggest original content that has not yet been previously submitted by the user. One or more embodiments of the invention can suggest original content to the user, where the original content is determined to be relevant, reliable, and presented in a preferred format.

One or more embodiments of the invention can suggest information to the user that the user would otherwise need to spend time to find. As such, by suggesting information based at least in part on the determined cognitive context of the user, one or more embodiments of the invention can allow the user to save searching time and cost. Further, if the user approves of the suggested content, one or more embodiments of the invention can allow the user to automatically input the suggested information directly into the application document.

One or more embodiments of the invention determine the cognitive context of the user based at least in part on information that the user has inputted (into an application document) and also based on multiple parameters. These multiple parameters can include, for example, types of computer activity by the user, historical methods of accessing information by the user, sources of information that the user has accessed (e.g., online sources, sources from a particular repository, sources from a particular entity, and/or certain online or offline documents), keywords that are used by the user, online conversations of the user, recorded comments/remarks by the user, and/or information accessible from the user's social media. One or more embodiments of the invention can then use the determined cognitive context to dynamically determine content that should be suggested to the user.

With one or more embodiments of the invention, an application can implement an algorithm that runs as a background process to determine the cognitive context of a user. The background process can monitor the user's inputs and can monitor other user actions. By monitoring the user's inputs and actions, one or more embodiments of the invention can determine the above-described parameters for determining the user's cognitive context. Next, suppose that the user inputs information regarding a particular topic within an application document.

With one or more embodiments of the invention, the application that is running the background process can determine the particular topic that the user is writing about within the application document. The algorithm of the background process can be a natural-language programming algorithm that monitors whether the user has used any keywords which are associated with content that can be suggested to the user. The natural-language programming algorithm can auto-populate fields/entries of the application document with suggested content. As such, if the application suggests content that the user approves of, then the user can simply input the suggested content into the document without needing to explicitly perform a manual search for the content that has been suggested.

In order to determine whether retrieved information is retrieved from a sufficiently reliable and/or trustworthy source (and to determine whether the retrieved information should be included within the suggested content), one or more embodiments of the invention can determine where the user has historically accessed information. For example, the background process can monitor where the user has accessed information. One or more embodiments of the invention can also determine whether retrieved information is sufficiently reliable and/or trustworthy by using the background process to analyze a prominence ranking/rating and/or a validity ranking/rating of blogs, social media sites, ratings sites, news sites, etc.

In addition to suggesting content that is derived from information sources from which the user has historically accessed, one or more embodiments of the invention can use the information derived from these historically-accessed sources to determine alternative information to suggest to the user. The alternative information can be information that is correlated to, or has some relation with, the original information that is derived from the historical sources. For example, suppose that the user inputs alphanumeric characters that identify a particular topic (such as a first brand of luxury cars). In addition to suggesting information regarding the first brand of luxury cars, one or more embodiments of the invention can also suggest alternative information that is correlated to (and/or related to) the first brand of luxury cars. Such alternative information can include information regarding a different, second brand of luxury cars, for example.

When content is suggested to the user, one or more embodiments of the invention can also allow the user or modify/reformat the suggested content. For example, one or more embodiments of the invention can allow a user to modify/reformat the suggested content by adding data, removing data, adding columns, removing columns, adding rows, removing rows, rearranging rows, rearranging columns, renaming categories of data, modifying the appearance of data, and/or reordering of data, etc. As the user modifies/reformats the suggested content, one or more embodiments of the invention can learn about how the user modifies/reformats the suggested content. After learning about how the user modifies/reformats suggested content, one or more embodiments of the invention can automatically perform the modifications/reformatting of the modified suggested content to the user. Therefore, when the suggested content is inputted into the application document, the suggested content has already been modified/reformatted in accordance to the user's preferences.

With one or more embodiments of the invention, the background process can operate in conjunction with a machine-learning system. The machine-learning system can function as a cognitive analyzer that determines a cognitive context of the user. The cognitive analyzer can include machine-learning algorithms. As described above, the background process can determine which information sources that a user considers to be relevant and/or reliable, can determine suggested content from these information sources that the user is more likely to input into the application document, and/or can determine how to modify/reformat the suggested content into a format that the user prefers. The machine-learning system can determine the cognitive context of the user, and the machine-learning system can determine suggested content based at least in part on the determined cognitive context. In order to learn how to determine the cognitive context of the user, the machine-learning algorithms of the cognitive analyzer can receive one or more of the following as training data inputs to the machine-learning algorithms: user-inputted information, the user's computer activity, historical methods of accessing information by the user, sources of information that the user has accessed, keywords used by the user, online conversations, the user's social media information, etc. The machine-learning algorithms are configured and arranged to apply machine learning techniques to the received training data inputs in order to, over time, create/train/update a unique model that determines the cognitive context of the user. One or more embodiments of the invention can then use the determined cognitive context to suggest content to the user. The machine-learning algorithms can receive feedback in the form of the user's acceptance or rejection of the suggested content. Further, the machine-learning system can also receive feedback that reflects how the user modified/reformatted the suggested content. The machine-learning algorithms can then adjust the model in order to more closely arrive at the desired suggested content.

The machine-learning system used in accordance with embodiments of the invention can be implemented by, for example, one or more artificial neural networks (ANNs), which can use electronic components that mimic the processing architecture of the human brain. Artificial neural networks are often embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning.

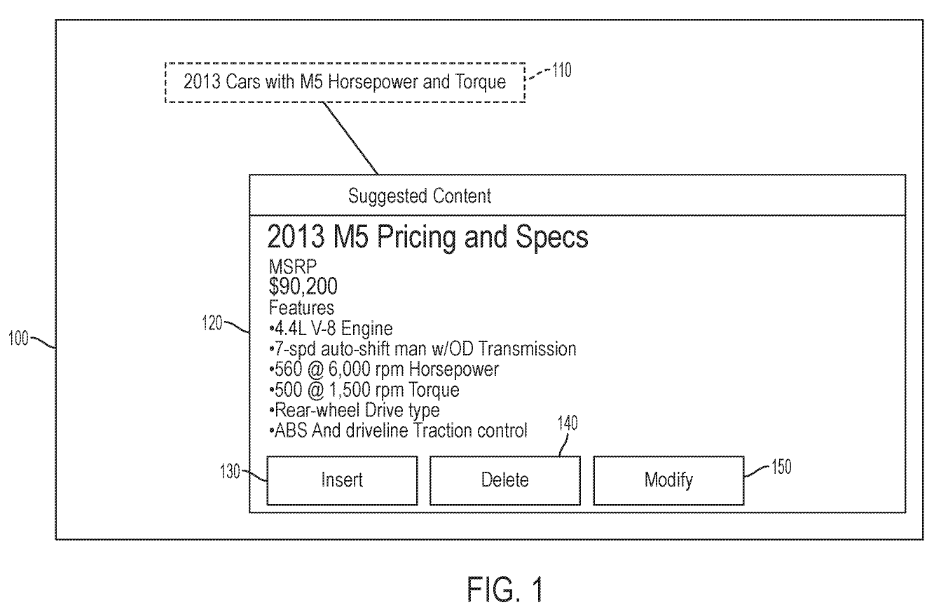

Turning now to a more detailed description of aspects of the invention, FIG. 1 illustrates inputting information and suggesting content in accordance with one or more embodiments of the invention. In the example of FIG. 1, the user begins inputting information 110 into an application document 100. For example, the user can type the words “2013 Cars with M5 Horsepower and Torque” into an entry/table of application document 100. Based at least in part on a determined cognitive context for the user, one or more embodiments of the invention can automatically retrieve information from a source that has been determined to be reliable and relevant. This source can be, for example, a reliable database, a reliable internet source, and/or a reliable offline document.

The retrieved reliable information can be suggested to the user as suggested content 120. In the example of FIG. 1, suggested content 120 can be based at least in part on the inputted information 110 (i.e., “2013 Cars with M5 Horsepower and Torque”), and one or more embodiments of the invention can display suggested content 120 to the user as possible content that can be used to auto-populate application document 100. After suggested content 120 is presented to the user, the user can insert suggested content 120 via insert button 130, the user can delete suggested content 120 via delete button 140, or modify/reformat suggested content 120 via modify button 150. Once the suggested content 120 is displayed to the user, the user can indicate whether or not suggested content 120 should be inputted within the application document 100.

If the user indicates that suggested content 120 should not be inputted within application document 100, then suggested content 120 can be removed from further consideration by the user. The above-described background process of one or more embodiments of the invention can then learn from the user's indication of whether or not the suggested content is to be inputted. As such, the background process can learn the user's preferred suggested content over time.

As described above, one or more embodiments of the invention can also determine alternative information that can be included within content that is suggested to the user. Specifically, if the user indicates that a first suggested content should not be inputted, the information of the first suggested content can still be used to generate alternative information. This alternative information can then be included within a second suggested content for the user. As described above, one or more embodiments of the invention can determine the alternative information based at least in part on information that is correlated to the first suggested content. The reliability/trustworthiness of the alternative information can also be determined based at least in part on using the background process to analyze a prominence ranking and/or validity ranking of blogs, social media sites, ratings sites, news sites, etc.

The displayed suggested content can also include a hyperlink that is associated with the suggested content. The hyperlink can link the user to the source from where the suggested content is derived from. The user can then review the source in order to confirm the reliability/authenticity of the suggested content. After the user confirms or refutes the reliability/authenticity of the suggested content, the user can then either accept or reject the suggested content. The background process can also learn which sources that the user considers to be reliable.

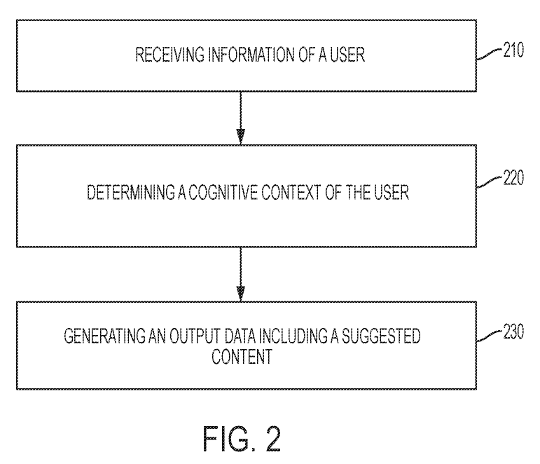

FIG. 2 depicts a flowchart of a method in accordance with one or more embodiments of the invention. The method of FIG. 2 can be performed by a controller of a system that is configured to suggest content based at least in part on a determined cognitive context. The method of FIG. 2 can be performed by a machine-learning system. As described above, the machine-learning system can be based at least in part on, for example, one or more artificial neural networks (ANNs), which can use electronic components that mimic the processing architecture of the human brain. With one or more embodiments of the invention, reconfigurable weights can be applied simultaneously to multiple inputs which involve monitoring the activities of the respective user. The user can perform activities using smart devices and/or wearables, for example, and these activities can be monitored by using screen capture and/or keyloggers to decrypt necessary information relating to the user's activities. By obtaining/decrypting the necessary information, one or more embodiments of the invention can track the cognitive state and the activity of the user. With one or more embodiments of the invention, the machine-learning system can receive one or more inputs including: (1) a time spent by the user on a source that has been determined/ranked as being relevant (which can be used to establish one or more confidence levels for the respective source), (2) identified blogs or pages (that the user has subscribed to) in conjunction with rankings that reflects a trustworthiness of such sources, (3) a schedule of the user (as reflected by the user's calendar/meetings), (4) an agenda of the user (as reflected by the user's scheduled tasks/items), and/or (5) identified items that are currently in development by the user (as reflected by performing a natural-language processing and/or a semantic analysis of documented user statements, for example), etc.

With one or more embodiments of the invention, one or more of the above-described inputs can be fed as inputs into the machine-learning system in order to determine an importance of one or more sources that are ranked/identified as being relevant. By determining relevant sources that are important to the user, one or more embodiments of the invention can suggest content from these important/trusted sources. One or more embodiments of the invention can also modify/reformat the suggested content based on the user's monitored preferences. Suggested content can be initially provided to the user in the form of multiple pre-defined graphical-user-interface templates. The formatting that the user selects for the suggested content can be considered by the machine-learning system by submitting the selected formatting as feedback into the machine-learning system. By submitted the selected formatting as feedback, one or more embodiments of the invention can further reinforce/enhance a confidence level in a specific categorization and classification of items under a specific formatting.

The method includes, at block 210, receiving, by a controller, information of a user. The information is targeted for inclusion within an application document. The method also includes, at block 220, determining a cognitive context of the user. The method also includes, at block 230, generating, by the controller, an output data comprising a suggested content. The suggested content is based at least in part on the determined cognitive context.

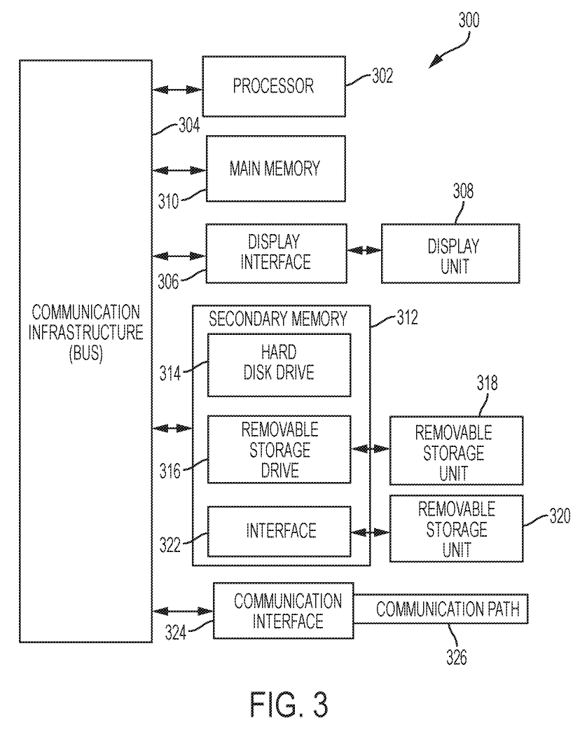

FIG. 3 depicts a high-level block diagram of a computer system 300, which can be used to implement one or more embodiments of the invention. Computer system 300 can correspond to or operate in conjunction with, at least, a machine-learning system that is configured to determine a content suggestion based at least in part on a determined cognitive context, for example. Computer system 300 can be used to implement hardware components of systems capable of performing methods described herein. Although one exemplary computer system 300 is shown, computer system 300 includes a communication path 326, which connects computer system 300 to additional systems (not depicted) and can include one or more wide area networks (WANs) and/or local area networks (LANs) such as the Internet, intranet(s), and/or wireless communication network(s). Computer system 300 and additional system are in communication via communication path 326, e.g., to communicate data between them.

Computer system 300 includes one or more processors, such as processor 302. Processor 302 is connected to a communication infrastructure 304 (e.g., a communications bus, cross-over bar, or network). Computer system 300 can include a display interface 306 that forwards graphics, textual content, and other data from communication infrastructure 304 (or from a frame buffer not shown) for display on a display unit 308. Computer system 300 also includes a main memory 310, preferably random access memory (RAM), and can also include a secondary memory 312. Secondary memory 312 can include, for example, a hard disk drive 314 and/or a removable storage drive 316, representing, for example, a floppy disk drive, a magnetic tape drive, or an optical disc drive. Hard disk drive 314 can be in the form of a solid state drive (SSD), a traditional magnetic disk drive, or a hybrid of the two. There also can be more than one hard disk drive 314 contained within secondary memory 312. Removable storage drive 316 reads from and/or writes to a removable storage unit 318 in a manner well known to those having ordinary skill in the art. Removable storage unit 318 represents, for example, a floppy disk, a compact disc, a magnetic tape, or an optical disc, etc. which is read by and written to by removable storage drive 316. As will be appreciated, removable storage unit 318 includes a computer-readable medium having stored therein computer software and/or data.

In alternative embodiments of the invention, secondary memory 312 can include other similar means for allowing computer programs or other instructions to be loaded into the computer system. Such means can include, for example, a removable storage unit 320 and an interface 322. Examples of such means can include a program package and package interface (such as that found in video game devices), a removable memory chip (such as an EPROM, secure digital card (SD card), compact flash card (CF card), universal serial bus (USB) memory, or PROM) and associated socket, and other removable storage units 320 and interfaces 322 which allow software and data to be transferred from the removable storage unit 320 to computer system 300.

Computer system 300 can also include a communications interface 324. Communications interface 324 allows software and data to be transferred between the computer system and external devices. Examples of communications interface 324 can include a modem, a network interface (such as an Ethernet card), a communications port, or a PC card slot and card, a universal serial bus port (USB), and the like. Software and data transferred via communications interface 324 are in the form of signals that can be, for example, electronic, electromagnetic, optical, or other signals capable of being received by communications interface 324. These signals are provided to communications interface 324 via a communication path (i.e., channel) 326. Communication path 326 carries signals and can be implemented using wire or cable, fiber optics, a phone line, a cellular phone link, an RF link, and/or other communications channels.

In the present description, the terms “computer program medium,” “computer usable medium,” and “computer-readable medium” are used to refer to media such as main memory 310 and secondary memory 312, removable storage drive 316, and a hard disk installed in hard disk drive 314. Computer programs (also called computer control logic) are stored in main memory 310 and/or secondary memory 312. Computer programs also can be received via communications interface 324. Such computer programs, when run, enable the computer system to perform the features discussed herein. In particular, the computer programs, when run, enable processor 302 to perform the features of the computer system. Accordingly, such computer programs represent controllers of the computer system. Thus it can be seen from the foregoing detailed description that one or more embodiments of the invention provide technical benefits and advantages.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

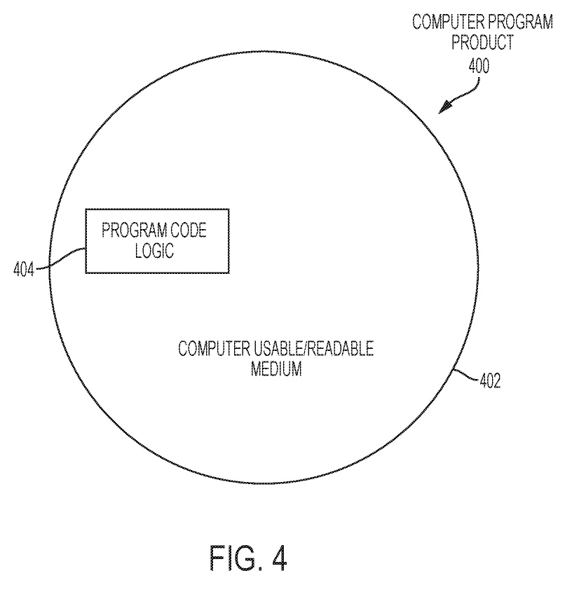

FIG. 4 depicts a computer program product 400, in accordance with an embodiment of the invention. Computer program product 400 includes a computer-readable storage medium 402 and program instructions 404.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments of the invention, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A computer-implemented method comprising:
receiving, by a controller, information of a user, wherein the information is targeted for inclusion within an electronic application document;
determining a cognitive context of the user;
generating, by the controller, an output data comprising a suggested content, wherein the suggested content is based at least in part on the determined cognitive context;
presenting, through graphical user interface templates, a first instance of the suggested content to the user;
learning, by the processor, any modification made by the user to the suggested content;
loading, by the processor, the first instance of the suggested content to the electronic application document, wherein the first instance of the suggested content includes any modification; and
presenting, through the graphical user interface temples, a second instance of the suggested content, wherein the second instance of the suggested content includes the any modification made by the user to the first instance of the suggested content.

2. The computer-implemented method of claim 1, wherein generating the output data comprises formatting the suggested content based at least in part on the determined cognitive context.

3. The computer-implemented method of claim 1, wherein the controller is configured to automatically fill the suggested content within the electronic application document upon approval by the user.

4. The computer-implemented method of claim 1, wherein determining the cognitive context of the user comprises determining at least one information source that the user considers to be reliable.

5. The computer-implemented method of claim 1, wherein determining the cognitive context of the user comprises determining a formatting of the suggested content that the user prefers.

6. The computer-implemented method of claim 1, wherein determining the cognitive context of the user comprises learning sources of information that the user has historically accessed.

7. The computer-implemented method of claim 1, wherein the controller operates with an artificial neural network that is configured to learn the cognitive context of the user.

8. A computer system comprising:
a memory; and
a processor system communicatively coupled to the memory;
the processor system configured to perform a method comprising:
receiving information of a user, wherein the information is targeted for inclusion within an electronic application document;
determining a cognitive context of the user;
generating an output data comprising a suggested content, wherein the suggested content is based at least in part on the determined cognitive context;
presenting, through graphical user interface templates, a first instance of the suggested content to the user;
learning, by the processor, any modification made by the user to the suggested content;
loading, by the processor, the first instance of the suggested content to the electronic application document, wherein the first instance of the suggested content includes any modification; and
presenting, through the graphical user interface temples, a second instance of the suggested content, wherein the second instance of the suggested content includes the any modification made by the user to the first instance of the suggested content.

9. The computer system of claim 8, wherein generating the output data comprises formatting the suggested content based at least in part on the determined cognitive context.

10. The computer system of claim 8, wherein the processor system is configured to automatically fill the suggested content within the electronic application document upon approval by the user.

11. The computer system of claim 8, wherein determining the cognitive context of the user comprises determining at least one information source that the user considers to be reliable.

12. The computer system of claim 8, wherein determining the cognitive context of the user comprises determining a formatting of the suggested content that the user prefers.

13. The computer system of claim 8, wherein determining the cognitive context of the user comprises learning sources of information that the user has historically accessed.

14. The computer system of claim 8, wherein the computer system operates with an artificial neural network that is configured to learn the cognitive context of the user.

15. A computer program product comprising a computer-readable storage medium having program instructions embodied therewith, the program instructions readable by a processor system to cause the processor system to:
receive information of a user, wherein the information is targeted for inclusion within an electronic application document;
determine a cognitive context of the user;
generate an output data comprising a suggested content, wherein the suggested content is based at least in part on the determined cognitive context;
present, through graphical user interface templates, a first instance of the suggested content to the user;
learn, by the processor, any modification made by the user to the suggested content;
load, by the processor, the first instance of the suggested content to the electronic application document, wherein the first instance of the suggested content includes any modification; and
present, through the graphical user interface temples, a second instance of the suggested content, wherein the second instance of the suggested content includes the any modification made by the user to the first instance of the suggested content.

16. The computer program product of claim 15, wherein generating the output data comprises formatting the suggested content based at least in part on the determined cognitive context.

17. The computer program product of claim 15, wherein the processor system is configured to automatically fill the suggested content within the electronic application document upon approval by the user.

18. The computer program product of claim 15, wherein determining the cognitive context of the user comprises determining at least one information source that the user considers to be reliable.

19. The computer program product of claim 15, wherein determining the cognitive context of the user comprises determining a formatting of the suggested content that the user prefers.

20. The computer program product of claim 15, wherein determining the cognitive context of the user comprises learning sources of information that the user has historically accessed.
